(19) United States
(12) Patent Application Publication
(10) Pub. No.: US 2012/0028013 A1
(43) Pub. Date: Feb. 2, 2012

(54) CONDUCTIVE POLARIZED FILM, METHOD FOR MANUFACTURING THEREOF AND DISPLAY OR INPUT DEVICE INCLUDING THEREOF

(75) Inventors: Shoichi MATSUDA, Osaka (JP); Yoshimasa SAKATA, Osaka (JP); Tadayuki KAMEYAMA, Osaka (JP)

(73) Assignee: NITTO DENKO CORPORATION, Osaka (JP)

(21) Appl. No.: 13/179,984

(22) Filed: Jul. 11, 2011

(30) Foreign Application Priority Data
Jul. 29, 2010 (JP) 2010-170734

(51) Int. Cl. B32B 7/02; B32B 3/00; B05D 5/12; B32B 13/04

(52) U.S. Cl. 428/213; 428/446; 428/336; 427/527

(57) ABSTRACT

The present invention to provide a conductive polarized film that has excellent see-through visibility and heat resistance, and low resistivity. The conductive polarized film of the present invention has a support film, an organic dye film, a silicon nitride layer and a transparent conductive film, in that order.

### CROSS-REFERENCE TO RELATED APPLICATIONS

This application claims priority to Japanese Application No. 2010-170734 filed in Japan on Jul. 29, 2010. The entire disclosures of Japanese Application No. 2010-170734 is incorporated hereinto by reference.

### BACKGROUND OF THE INVENTION

1. Field of the Invention

The present invention relates to a conductive polarized film, a method for manufacturing this film and a display or input device that includes this film.

2. Background Information

Display and input devices that combine a display device such as a liquid crystal display with a touch panel (input device) have been put to practice use in recent years. For example, they have been used for the manipulation panels of portable telephones, portable music players, printers and so forth. With these display and input devices, the user can intuitively operate a device by pressing on the display shown on the screen.

When such display and input devices are used, however, the user inevitably sees the display of the display device through the input device, so a problem is that display visibility is diminished because of the presence of the input device.

To solve this problem, the input device and the display device may be integrated, for example. Japanese Laid-Open Patent Application S62-86328 discloses a conductive polarized film in which an indium tin oxide (ITO) layer (a transparent conductive layer) is formed over the surface on one side of a polarized plate (Example 1). This display and input device featuring a conductive polarized film has good optical transmittance and excellent visibility of the display on the display device.

Nevertheless, the polarized plate that is usually used is produced by sandwiching a polyvinyl alcohol film that has been dyed with iodine between triacetyl cellulose films, and has poor heat resistance. More specifically, such a plate must be used below 80° C., for example.

Therefore, in the manufacture of the conductive polarized film in the above-mentioned patent document, an ITO layer cannot be formed at a high film formation temperature. In fact, in the manufacture of the conductive polarized film in the above-mentioned patent document, an ITO layer is formed by low-temperature sputtering.

However, the formation temperature of an ITO layer or other such transparent conductive film is closely related to the resistivity of the transparent conductive film that is formed. Accordingly, a problem with the ITO layer in the conductive polarized film in the above-mentioned patent document is high resistivity.

Also, because of the poor heat resistance of the conductive polarized film after manufacture, there are limitations on the usage temperature.

### SUMMARY OF THE INVENTION

In light of these problems, it is an object of the present invention to provide a conductive polarized film that has excellent see-through visibility and heat resistance, and low resistivity.

To achieve this object, the inventors first tried to form a transparent conductive film on an organic dye film by using an organic dye film with excellent heat resistance (more specifically, one that can be used at 100° C. or higher) in place of the polarized plate that is usually used as discussed above.

To obtain a display and input device with excellent visibility of the display, it is necessary for the conductive polarized film being used to have good see-through visibility, but the transparent conductive films formed in the above-mentioned attempts were uneven, and a conductive polarized film with excellent see-through visibility could not be obtained.

In view of this, the inventors conducted further research, and as a result arrived at the present invention upon discovering that a uniform transparent conductive film can be formed by forming a silicon nitride layer on the surface of an organic dye film, and then forming a transparent conductive film by sputtering on the surface of this silicon nitride layer.

The present invention provides a conductive polarized film having:
a support film,
an organic dye film,
a silicon nitride layer and
a transparent conductive film, in that order.

Further the present invention provides a method for manufacturing the conductive polarized film having:
a step A of forming an organic dye film by coating the surface of a support film with a coating solution containing an organic dye;
a step B of forming a silicon nitride layer on the surface of the organic dye film formed in step A; and
a step C of forming a transparent conductive film by sputtering at a film formation temperature of at least 100° C. on the surface of the silicon nitride layer formed in step B.

Moreover the present invention provides a display and input device includes a conductive polarized film of the above.

According to the present invention, it is possible to provide a conductive polarized film that has excellent see-through visibility and heat resistance, and low resistivity.

### BRIEF DESCRIPTION OF THE DRAWINGS

Referring now to the attached drawings which form a part of this original disclosure:

FIG. 1 is a cross-sectional view showing the simplified structure of the conductive polarized film according to the one embodiment of the present invention;

FIG. 2 is a polarizing microphotography of the surface of the conductive polarized film according to the Example 1;

FIG. 3 is a polarizing microphotography of the surface of the conductive polarized film according to the Comparative Example 1.

### DETAILED DESCRIPTION OF THE PREFERRED EMBODIMENTS

The conductive polarized film of the present invention will now be described in detail.

As discussed above, the conductive polarized film of the present invention has a support film, an organic dye film, a silicon nitride layer and a transparent conductive film, in that order.

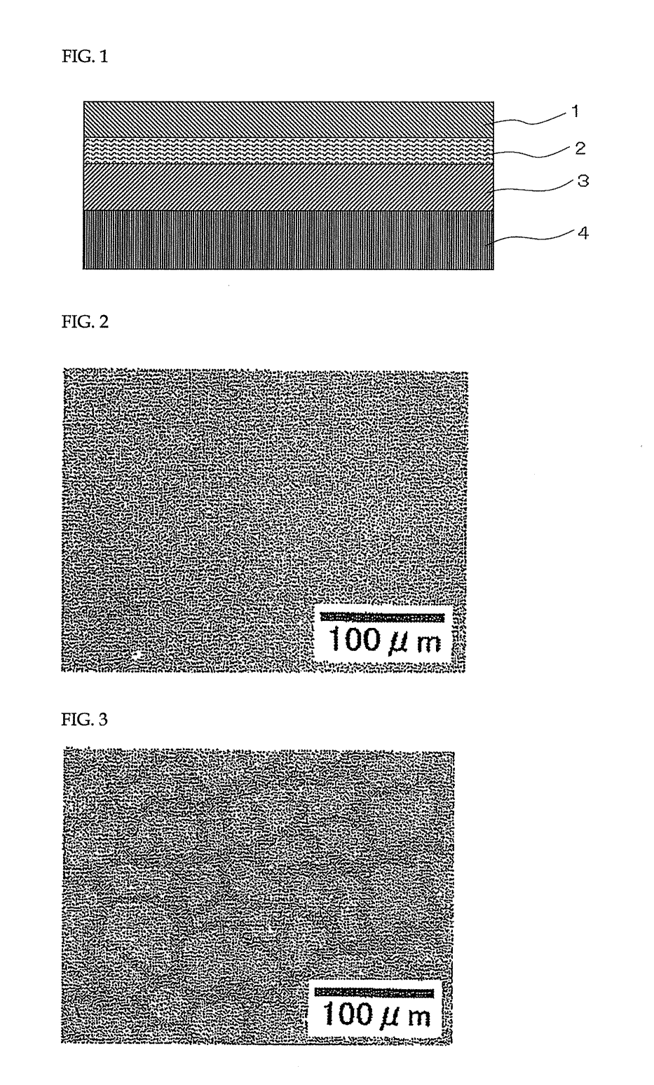

FIG. 1 shows the simplified structure in one aspect of the conductive polarized film of the present invention. In FIG. 1, 1 is a transparent conductive film, 2 is a silicon nitride layer, 3 is an organic dye film and 4 is a support film.

The conductive polarized film of the present invention is characterized in that its see-through visibility and heat resistance are excellent, and resistivity is low.

As to the see-through visibility, the total light transmittance in the visible light band (380 to 780 nm) of the conductive polarized film of the present invention is preferably at least 80%, and more preferably at least 85%. The total light transmittance is measured as set forth in Measurement Method A of JIS K 7105.

The haze of the conductive polarized film of the present invention is preferably no more than 10%, and more preferably no more than 5%. Haze is measured as set forth in the method given in JIS K 7136. Haze is correlated to the uniformity of the conductive polarized film.

As to heat resistance, more specifically the conductive polarized film of the present invention tend to undergo no deformation or decrease in its properties (such as degree of polarization) when used continuously at 100° C., for example.

The resistivity of the transparent conductive film in the conductive polarized film of the present invention is preferably no more than 5×10⁻⁴ Ω·cm. The resistivity of the transparent conductive film in the conductive polarized film of the present invention is preferably low, and while there is no lower limit thereof, it is usually at least 2×10⁻⁴ Ω·cm.

The total thickness of the conductive polarized film of the present invention is preferably 15 to 130 μm.

### 1. Support Film

The support film in the conductive polarized film of the present invention supports the organic dye film, the silicon nitride layer, and the transparent conductive film laminated on the surface of the support film.

The support film preferably has excellent transparency.

The total light transmittance in the visible light band (380 to 780 nm) of the support film is preferably at least 80%, and more preferably at least 85%. The total light transmittance is measured as set forth in Measurement Method A of JIS K 7105.

The haze of the support film is preferably no more than 10%, and more preferably no more than 5%. Haze is measured as set forth in the method given in JIS K 7136. Haze is correlated to the uniformity of the conductive polarized film.

The support film also preferably has excellent heat resistance.

The heat resistance of the support film is expressed by the load bending temperature of the material that forms the support film. The load bending temperature of the material that forms the support film is preferably at least 100° C., and more preferably at least 120° C. The load bending temperature is measured as set forth in the method given in JIS 7191.

A cyclo-olefin-based resin, a polyallylate-based resin, polyetheretherketone-based resin, polyester-based resin and the like are an example of the material that forms the support film.

The support film may be subjected to orientation, adhesion improvement, or other such processing. Examples of orientation include mechanical orientation such as rubbing, and chemical orientation such as optical orientation processing. Examples of adhesion improvement include corona processing, plasma processing, UV processing and the like.

The thickness of the support film may be usually 15 to 120 μm.

### 2. Organic Dye Film

The organic dye film is disposed on one surface of the support film.

The organic dye film in the conductive polarized film of the present invention has an organic dye as its main component, and exhibits absorption dichroism at wavelengths between 400 and 780 nm. The proportion in which the organic dye is contained in the organic dye film is preferably at least 80 wt % with respect to the total weight of the organic dye film.

An example of an organic dye is an azo-based, an anthraquinone-based, a phthalocyanine-based, a perylene-based, a quinophthalone-based, a naphthoquinone-based, a metallocyanine-based dyes, and other such dye. Among organic dyes, those that enter the liquid phase in solution (such as an aqueous solution) (specifically, those that exhibit lyotropic liquid crystal properties) are preferable because they exhibit a high dichroic ratio when applied on the support film. An organic dye that exhibits lyotropic liquid crystal properties can be synthesized, for example, by the method discussed in Japanese Laid-Open Patent Application 2009-173849, or the method discussed in Japanese Laid-Open Patent Application 2009-115866. The thickness of the organic dye film of the present invention is preferably 100 to 10,000 nm, and more preferably 100 to 1,000 nm.

### 3. Silicon Nitride Layer

The silicon nitride layer is disposed on the surface of the organic dye film, on the opposite side from the support film.

Silicon nitride is a compound expressed by the general formula SiNₓ (such as Si₃N₄), and the layer formed from this material exhibits excellent heat resistance and mechanical strength. Also, since silicon nitride has good acid resistance, it will not be degraded by an acid dye even if an acid dye is used as the organic dye.

The silicon nitride layer suppresses expansion and contraction of the organic dye film caused by temperature changes during the formation of the transparent conductive film (described in detail below), and it is surmised that this makes it possible to form a uniform transparent conductive film, but the present invention is not limited to or by this.

The ratio in which the silicon nitride is contained in the silicon nitride layer is preferably at least 90 wt % with respect to the total weight of the silicon nitride layer. The thickness of the silicon nitride layer is preferably 10 to 1,000 μm, and more preferably 50 to 500 nm.

If the silicon nitride layer is too thin, the transparent conductive film (described in detail below) may not be uniform.

The silicon nitride layer usually has good transparency, but if the silicon nitride layer is too thick, the optical transmittance of the conductive polarized film may be lost.

The ratio (dA/dB) of the thickness of the organic dye film (dA) to the thickness of the silicon nitride layer (dB) is preferably greater than 1 and no more than 100, and more preferably greater than 1 and no more than 10. If this ratio (dA/dB) is too low, cracks may develop in the organic dye film, of if it is too high, the surface of the silicon nitride layer may be uneven.

### 4. Transparent Conductive Film

The transparent conductive film is disposed on the surface of the silicon nitride layer, on the opposite side from the organic dye film. The transparent conductive film preferably has high optical transmittance in the visible light band (380 to 780 nm) and low haze. The optical transmittance is expressed by the total light transmittance in the visible light band (380 to 780 nm).

The total light transmittance in the visible light band (380 to 780 nm) of transparent conductive film is preferably at least 80%, and more preferably at least 85%. The total light transmittance is measured as set forth in Measurement Method A of JIS K 7105.

The haze of transparent conductive film is preferably no more than 10%, and more preferably no more than 5%. Haze is measured as set forth in the method given in JIS K 7136. Haze is correlated to the uniformity of the conductive polarized film.

The total light transmittance and haze are usually each measured in a state in which the film is supported on the support film, and are obtained by factoring in the haze value and total light transmittance of the support film, etc., that have been measured separately.

As mentioned above, the transparent conductive film preferably has low resistivity.

The resistivity of the transparent conductive film can be lowered by selecting a good material for the transparent conductive film, or by adjusting the film formation temperature (described in detail below).

A representative example of the transparent conductive film is an indium tin oxide (ITO) layer, an indium oxide-zinc oxide (IZO) layer, and other such layers. Among these, IZO is preferable.

The thickness of the transparent conductive film is preferably 10 to 1,000 nm, and more preferably 50 to 500 nm.

### 5. Manufacturing Method

The method for manufacturing the conductive polarized film of the present invention comprises:

a step A of forming an organic dye film by coating the surface of a support film with a coating solution containing an organic dye;

a step B of forming a silicon nitride layer on the surface of the organic dye film formed in step A; and

a step C of forming a transparent conductive film by sputtering at a film formation temperature of at least 100° C. on the surface of the silicon nitride layer formed in step B.

### a) Step A

Step A is a step of forming an organic dye film by coating the surface of a support film with a coating solution containing an organic dye.

The coating solution is prepared by dissolving an organic dye in an aqueous solvent (such as water) or an organic solvent. Examples of how the coating solution is applied include the use of a slide coater, a slotted die coater and a bar coater.

After Step A, a drying step may be carried out prior to step B in order to adjust the amount of solvent in the organic dye film. Heating may be performed here to promote drying.

### b) Step B

Step B is a step of forming a silicon nitride layer on the surface of the organic dye film formed in step A. The silicon nitride layer can be formed by a chemical vapor deposition (CVD) method, for example.

### c) Step C

Step C is a step of forming a transparent conductive film by sputtering at a film formation temperature of at least 100° C. on the surface of the silicon nitride layer formed in step B.

The above-mentioned sputtering is a process in which a plasma is generated by discharge in a low-pressure gas, accelerating the cations in this plasma toward a negative electrode target so that they collide with the surface of the target, and depositing the substance scattered by this collision onto what is being coated (the silicon nitride layer in the present invention). In this sputtering, the film formation temperature is preferably at least 100° C., and more preferably 120 to 200° C. Setting the film formation temperature to at least 100° C. sufficiently lowers the resistivity of the transparent conductive film. On the other hand, if the film formation temperature is too high, the support film may melt.

The conductive polarized film of the present invention can be used to advantage as a constituent part of a touch panel or other such input device; a liquid crystal display, organic EL display, or other such display device; or functional glass, but the applications of the conductive polarized film of the present invention are not limited to these.

The conductive polarized film of the present invention can be used in the same manner as an ordinary polarized film, but since the transparent conductive film and the polarized plate can be considered to be integrated, the device manufacturing process discussed above can be eliminated. It can also be used to advantage in a display and input device that combines a display device with an input device.

The display and input device of the present invention includes a conductive polarized film.

The display and input device of the present invention may be a display and input device in which a display device and an input device are integrated.

### EXAMPLES

The present invention will now be described in detail by giving working and comparative examples, but these are merely intended to help describe specific examples of the present invention, and not to limit the scope of the invention.

Measurements in Example and Comparative Example were made by the following methods.

### (1) Observation of Liquid Crystal Phase

A small amount of coating liquid was sandwiched between two glass slides, and this product was observed with a polarizing microscope (“Opt1phot-Pol,” a trade name of Olympus) equipped with a large sample heating and cooling stage for a microscope (“10013L,” a trade name of Japan High Tech Co., Ltd.).

### (2) Measurement of Degree of Polarization of Organic Dye Film

The polarized transmission spectrum at wavelengths between 380 and 780 nm was measured using a spectrophotometer (“V-7100,” a trade name of JASCO Corporation) equipped with a Glan Thompson polarizer. This spectrum was used to find the transmittance Y₁ of linearly polarized light in the direction of maximum transmittance, and the transmittance Y₂ of linearly polarized light in the direction perpendicular to the direction of maximum transmittance, which had undergone visibility correction, and the degree of polarization was calculated from the following equation.

Degree of polarization=(Y₁−Y₂)/(Y₁+Y₂)

### (3) Observation of Surface of Conductive Polarized Film

The observation was conducted using a polarizing microscope (“OPT1PHOT-POL,” a trade name of Olympus).

### Example 1

### Synthesis of Organic Dye

4-Nitroaniline and 8-amino-2-naphthalenesulfonic acid were subjected to diazo conversion and coupling reactions by a standard method (“Riron Seizou Senryou Kagaku (Ver. 5) [Theoretical Production Dye Chemistry Volume No. 5],” Yutaka Hosoda (published on Jul. 15, 1968, by Gihodo, pp. 135-152), which gave a monoazo compound. This monoazo compound was similarly subjected to diazo conversion by a standard method, and then subjected to a coupling reaction with 1-amino-8-naphthol-2,4-disulfonic acid lithium salt, which gave a crude product containing the aromatic diazo compound of the following chemical formula (1) (hereinafter referred to as compound 1), and this was salted out with lithium chloride to obtain a refined compound 1.

This compound 1 was dissolved in deionized water to prepare a 20 wt % aqueous solution. This aqueous solution was sampled with a plastic dropper, sandwiched between two glass slides, and observed under a polarizing microscope at room temperature (23° C.). A nematic liquid crystal phase was observed.

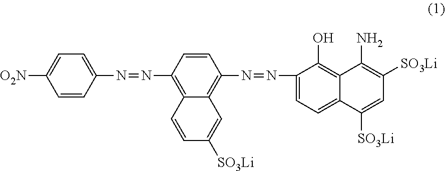

### Formation of Organic Dye Film

Compound 1 was dissolved in deionized water to prepare a pre-treatment solution with a concentration of 8 wt %. This pre-treatment solution was heated under stirring until the liquid temperature reached 90° C., then held at that temperature for 30 minutes, and allowed to cool in a 23° C. thermostatic chamber. The cooled solution (coating solution) was applied within one hour on an cyclo-olefin-based resin film that had undergone rubbing and corona treatment (“Zeonoa,” a trade name of Nihon Zeon), using a bar coater (“Mayer Rot HS5,” a trade name of Bushman), and this coating was naturally dried in a 23° C. thermostatic chamber to produce an organic dye film (thickness of 400 nm). This organic dye film exhibited absorption dichroism in the visible light band, and the degree of polarization was 99%.

### Formation of Silicon Nitride Layer

An SiNₓ film (thickness of 100 nm) was formed by plasma CVD on the surface of the organic dye film obtained above. The formation conditions were as follows.

Degree of vacuum: 2.25×10⁻³ Torr

SiH₄ gas flow: 50 sccm

Nitrogen gas flow: 50 sccm

Frequency: 13.56 MHz

Power: 700 W

### Formation of Transparent Conductive Film

An indium oxide-zinc oxide film (thickness of 100 nm) was formed by sputtering on the surface of the above-mentioned silicon nitride layer. The formation conditions were as follows.

Degree of vacuum: 3×10⁻³ Torr

Current of spattering: 5 A

Voltage of spattering: 300 V

Temperature of film formation: 130° C.

### Comparative Example 1

As Comparative Example 1, a conductive polarized film was produced in the same manner as the conductive polarized film in Example 1, except that no silicon nitride layer was formed, and the indium oxide-zinc oxide film was formed on the surface of the organic dye film.

### Evaluation

The conductive polarized film of Example 1 produced as above had a uniform surface. FIG. 1 shows a micrograph thereof. The conductive polarized film of Comparative Example 1 was not uniform on the surface. FIG. 2 shows a micrograph thereof.

The conductive polarized film of the present invention can be used to advantage in a touch panel, a liquid crystal display, an organic EL display, functional glass, and the like.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A conductive polarized film comprising:
a support film,
an organic dye film,
a silicon nitride layer and
a transparent conductive film, in that order.

2. The conductive polarized film of claim 1, wherein the total light transmittance in the visible light band is at least 80%, and the haze is no more than 10%.

3. The conductive polarized film of claim 1, wherein the resistivity of the transparent conductive film in the conductive polarized film is no more than 5×10⁻⁴ Ω·cm.

4. The conductive polarized film of claim 1, wherein the load bending temperature of the material that forms the support film is at least 100° C.

5. The conductive polarized film of claim 1, wherein the thickness of the silicon nitride layer is 10 to 1,000 nm.

6. The conductive polarized film of claim 1, wherein the ratio (dA/dB) of the thickness of the organic dye film (dA) to the thickness of the silicon nitride layer (dB) is greater than 1 and no more than 100.

7. A method for manufacturing the conductive polarized film comprising:
a step A of forming an organic dye film by coating the surface of a support film with a coating solution containing an organic dye;
a step B of forming a silicon nitride layer on the surface of the organic dye film formed in step A; and
a step C of forming a transparent conductive film by sputtering at a film formation temperature of at least 100° C. on the surface of the silicon nitride layer formed in step B.

8. The method of claim 7, wherein the thickness of the silicon nitride layer is 10 to 1,000 nm.

9. A display and input device includes a conductive polarized film of claim 1.

10. The display and input device of claim 9, wherein the display device and the input device are integrated.
